(19) United States
(12) Patent Application Publication
(10) Pub. No.: US 2008/0016266 A1
(43) Pub. Date: Jan. 17, 2008

(54) Method And Apparatus For Smart Storage Devices

(76) Inventor: Yi-Chun Liu, Hsinchu City (TW)

Correspondence Address: LIN & ASSOCIATES INTELLECTUAL PROPERTY, INC., P.O. BOX 2339, SARATOGA, CA, 95070-0339, US

(21) Appl. No.: 11/457,465

(22) Filed: Jul. 14, 2006

(51) Int. Cl. G06F 13/36

(52) U.S. Cl. 710/311

(57) ABSTRACT

A smart storage device that can be either used in conjunction with a conventional storage device or integrated into a conventional storage device to become a smart storage device is disclosed. The smart storage device of the present invention includes a transmission interface, a processor, a control interface, a storage medium, an input interface, an input device, a response interface, and a response device. The processor further includes a memory, a data transmission and medium control module, and a monitor, analysis and response (MAR) module. The MAR module is for monitoring and analyzing the operation requests and responding accordingly. When used in conjunction with a conventional storage device, the external smart storage device includes a host-end transmission interface, a processor, a device-end transmission interface, an input device, an input device, a response interface, and a response device. The processor further includes a memory, a transmission interface and data exchange module, and an MAR module. The transmission interface and data exchange module is for data format conversion between two interfaces.

### FIELD OF THE INVENTION

The present invention generally relates to a method and apparatus for smart storage devices, and more specifically to a method and apparatus able to monitor and analyze the host operations to a storage device and respond in accordance with the operations.

### BACKGROUND OF THE INVENTION

A storage device is an important part of electronic device, such as PC, PDA, mobile phones, digital camera, and so on. Conventional storage devices are considered as passive device, as they receive and respond to the operation requests from the electronic devices, such as data access.

FIG. 1 shows a schematic view of a conventional storage device 100 connected to a host 110. Storage device 100 includes a transmission interface 101, a processor 102, a storage interface 103 and a storage medium 104. Transmission interface 101 is connected to a transmission interface 111 of host 110 through a transmission medium. Processor 102 is connected to transmission interface 101, and further includes a memory 1021, interface data transmission module 1022, storage medium control module 1023. Storage interface 103 is connected to processor 102 and storage medium 104. The operation requests from host 110 are transmitted to storage device 100, and processor 102 executes the corresponding operations to the request.

Numerous researches and techniques have been developed to enhance the storage device and provide additional features, such as displaying volume information. U.S. Patent Publication No. 2006/0075182 A1 disclosed a storage control apparatus capable of analyzing volume information and display the volume information through a display device interface so that a user can independently read the storage device and the volume information.

U.S. Patent Publication No. 2005/0268032 A1 disclosed a semantic processor storage architecture that uses a semantic processor to parse and respond to the client requests to the storage device. The semantic processor parses the operation requests and generates/executes microcode segments in response to the requests. The disadvantage is that the original client requests and the actual requests to the storage device, although semantically equivalent, may be syntactically different, which may lead to further interface and compatibility issues.

### SUMMARY OF THE INVENTION

The present invention has been made to overcome the above-mentioned drawback of conventional storage devices. The primary object of the present invention is to provide a method and apparatus for a smart storage device capable of monitoring and analyzing the operation request from the connected electric device and respond accordingly.

Another object of the present invention is to provide a smart storage device that can be used in conjunction with a conventional storage device for monitoring and analyzing the operation request from the connected electric device and respond accordingly.

To achieve the aforementioned objects, the present invention provides a smart storage device that can be either used in conjunction with a conventional storage device or integrated with a conventional storage device to become a smart storage device. The smart storage device of the present invention includes a transmission interface, a processor, a control interface, a storage medium, an input interface, an input device, a response interface, and a response device. The processor further includes a memory, a data transmission and medium control module, and a monitor, analysis and response (MAR) module. The MAR module is for monitoring and analyzing the operation requests and responding accordingly. When used in conjunction with a conventional storage device, the external smart storage device includes a host-end transmission interface, a processor, a device-end transmission interface, an input device, an input device, a response interface, and a response device. The processor further includes a memory, a transmission interface and data exchange module, and an MAR module. The transmission interface and data exchange module is for data format conversion between two interfaces.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional storage device connected to a host;

FIG. 2 shows a schematic view of an embodiment of a smart storage device of the present invention;

FIG. 3 shows a second embodiment of a smart storage device of the present invention;

FIG. 4 shows a flowchart of the operational of a smart storage device of the present invention;

FIG. 5 shows a detailed flowchart of the operation of FIG. 4;

FIG. 6 shows the detailed monitoring, analysis and response process of FIG. 5;

FIGS. 7A and 7B show exterior and the interior of an embodiment of an external smart storage device shown in FIG. 3, respectively;

FIG. 8 shows a flowchart of the process for the LCD displaying animation sequence in the embodiment of FIGS. 7A and 7B;

FIG. 9 shows a selection menu that the user can operate with the buttons in the embodiment of FIGS. 7A and 7B;

FIG. 10 shows a flowchart of the operation of the embodiment of FIGS. 7A and 7B;

FIG. 11A shows a schematic view of the storage content of the embodiment of FIGS. 7A and 7B;

FIG. 11B shows a schematic view of the tree structure generated by the smart storage device for the FAT data structure; and

FIG. 11C shows a schematic view of a reverse FAT look-up table generated during the construction of the tree structure of FIG. 11B.

### DETAILED DESCRIPTION OF THE PREFERRED EMBODIMENTS

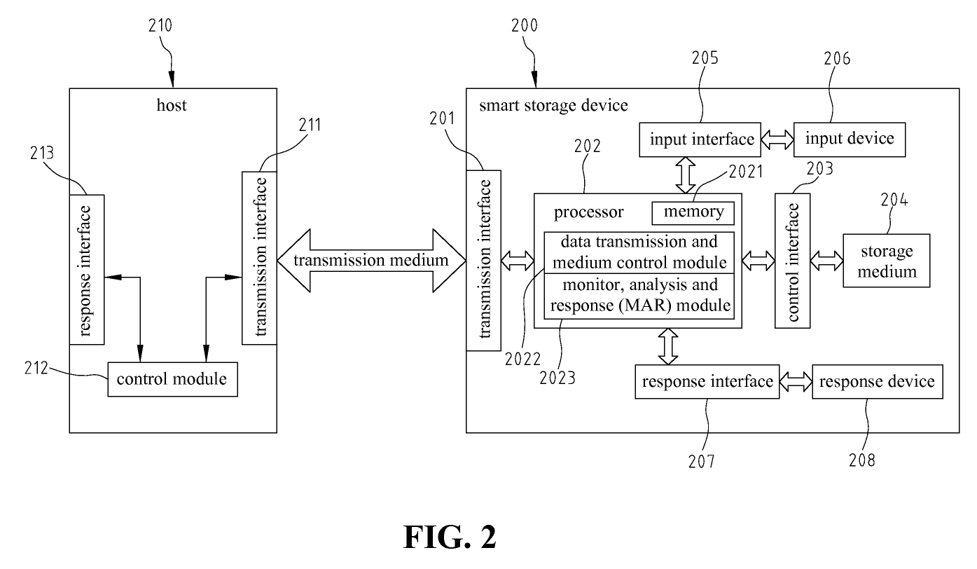

FIG. 2 shows a schematic view of an embodiment of a smart storage device of the present invention. As shown in FIG. 2, a smart storage device 200 is connected to a host 210. Storage device 200 includes a transmission interface 201, a processor 202, a control interface 203, a storage medium 204, an input interface 205, an input device 206, a response interface 207, and a response device 208. Transmission interface 201 is connected to a transmission interface 211 of host 210 through a transmission medium. Processor 202 is connected to transmission interface 201 and further includes a memory 2021, a data transmission and medium control module 2022, and a monitor, analysis and response (MAR) module 2023. Data transmission and medium control module 2022 controls the data transmission to the storage medium, as in conventional storage device. MAR module 2023 is for monitoring and analyzing the operation requests and responding accordingly. Control interface 203 is connected to processor 202 and storage medium 204. Storage medium 204 is for storing data, as in conventional storage device. Input interface 205 is connected to processor 202 and input device 206. Input device 206 is for receiving input for setting parameters. Response interface 207 is connected to processor 202 and response device 208. Response device 208 is for showing pre-determined response, such as text message, animation sequence, sounds, or control signals transmissible through network. It is preferably that input device 206 and response device 208 are included in the smart storage device to provide direct interaction with the user. However, the input device and the response device can also be connected to the smart storage device through network so that the user can remotely interact with the smart storage device of the present invention. In addition, the response that the response device shows can be audio-based, video-based, other sensory-based, or even control signals. The following description uses animation as embodiment for explanation, but equivalent response methods are also within the scope of the present invention.

In this embodiment, host 210 can further include a control module 212 and a response interface 213. Control module 212 is for setting parameters, receiving results and generating response. Response interface 213 is for receiving response from control module 212 and displaying responses. It is worth noticing that control module 212 and response interface 213 are optional. If a host is installed with a control module and a response interface, the host can be used to set the operational parameters for the storage device, and displaying the response from the storage device, such as showing status messages or animation. If the host is not installed with the control module and the response interface, the control of the smart storage device and the display of the response can only be through the input device and the response device on the smart storage device. Therefore, in the simplest application, the present invention can be used with conventional hosts without any change to the host.

Host 210 is not limited to any specific type. Any electronic devices, such as PC, PDA, digital camera, multimedia recorder and player, cellular phone, game console, and so on, are all applicable to the device of the present invention. Similarly, storage device 200 is not limited to any specific type. Any storage devices, such as floppy drive, hard drive, optical drive, card reader, flash memory pen, network storage device, and so on, are all applicable to the device of the present invention. Finally, the transmission medium and the related transmission interfaces 201, 211 are not limited to any specific type. The commonly standard interfaces, such as ATAPI, SATA, SCSI, USB, Ethernet IEEE1394, FDDI, IEEE802.11, Bluetooth, GPRS, and so on, are all applicable to the device of the present invention.

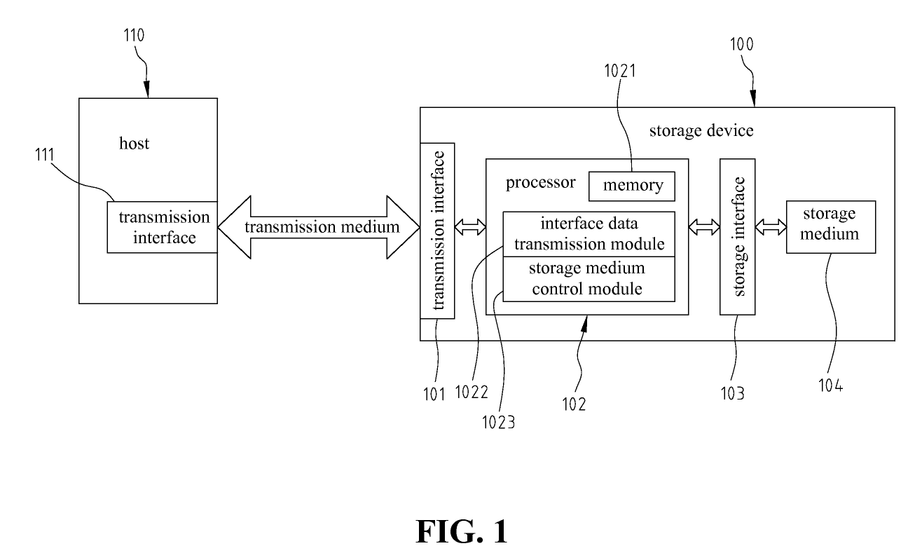

The difference between the embodiment of a smart storage device 200 of FIG. 2 and a conventional storage device 100 of FIG. 1 is that smart storage device 200 includes a MAR module in the processor to monitor, analyze and respond to the requests from the host, an input device to receive the parametric inputs from the user, and a response device to display the response using text or animation to the user. Therefore, a smart storage device of the present invention can detect the intention of the operation request from the host and display operational status to the user, such as through animation.

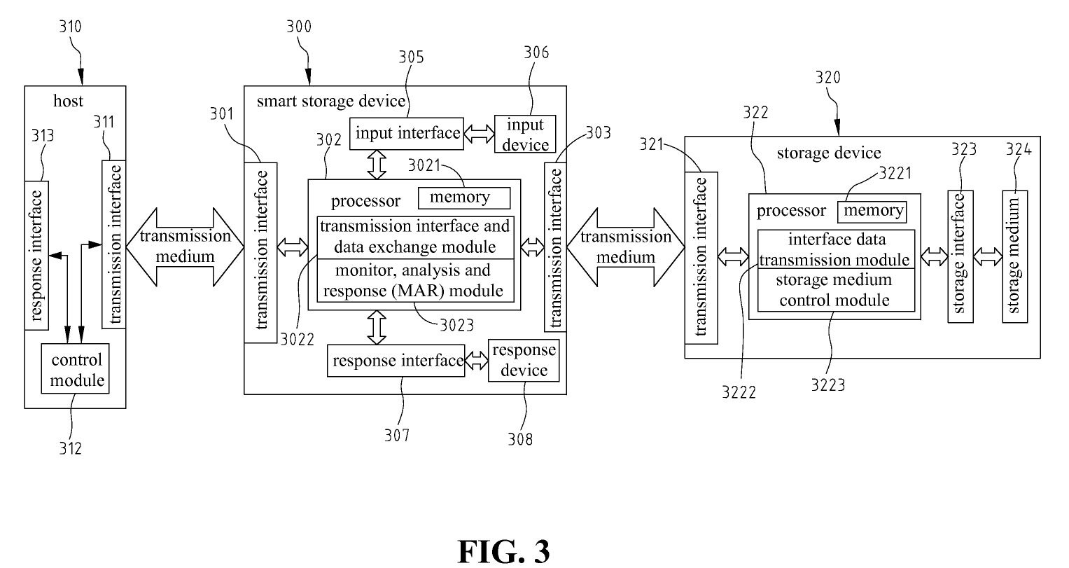

FIG. 3 shows a second embodiment of a smart storage device of the present invention. The second embodiment is similar to the first embodiment shown in FIG. 2, except that a smart storage device 300 is used as an external device between a host 310 and a conventional storage device 320. Host 310 and conventional storage device are identical to host 210 of FIG. 2 and conventional device 100 of FIG. 1, respectively. Therefore, the descriptions are omitted.

As shown in FIG. 3, an external smart storage device 300 includes a host-end transmission interface 301, a processor 302, a device-end transmission interface 303, an input device 305, an input device 306, a response interface 307, and a response device 308. Processor 302 further includes a memory 3021, a transmission interface and data exchange module 3022, and an MAR module 3023. Transmission interface and data exchange module 3022 is responsible for transmitting requests from host 310 to conventional storage device 320, and performing data conversion between different interfaces, if necessary. As host-end transmission interface 301 and device-end transmission interface 303 can use different transmission protocols, transmission interface and data exchange module 3022 of external smart storage device 300 must perform the necessary data conversion. This embodiment shows that a smart storage device of the present invention can also be used externally between a host and a conventional storage device.

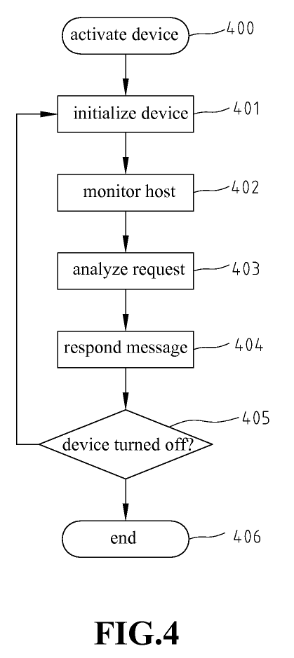

FIG. 4 shows a flowchart of the operational of a smart storage device of the present invention. The process starts with step 400 to activate the smart storage device. Step 401 is to initialize the smart storage device. The initialization includes suspending the storage device from responding to the host, determining the characteristics of the storage device, the existence of the storage medium, the file system information, and so on. After the initialization, step 402 is for the smart storage device to monitor the requests from the host, such as recording the type of the request and the related parameters. Step 403 is to analyze the intention of the requests, and step 404 is to generate response to the analyzed requests. Step 405 is to determine whether the smart storage device is being turned off; and if so, step 406 is to exit; otherwise, return to step 402 to continue the monitoring, analysis and response to the requests from the host until the smart storage is turned off. The turn-off events may include a shot-down request from the host, or a power failure signal, and so on.

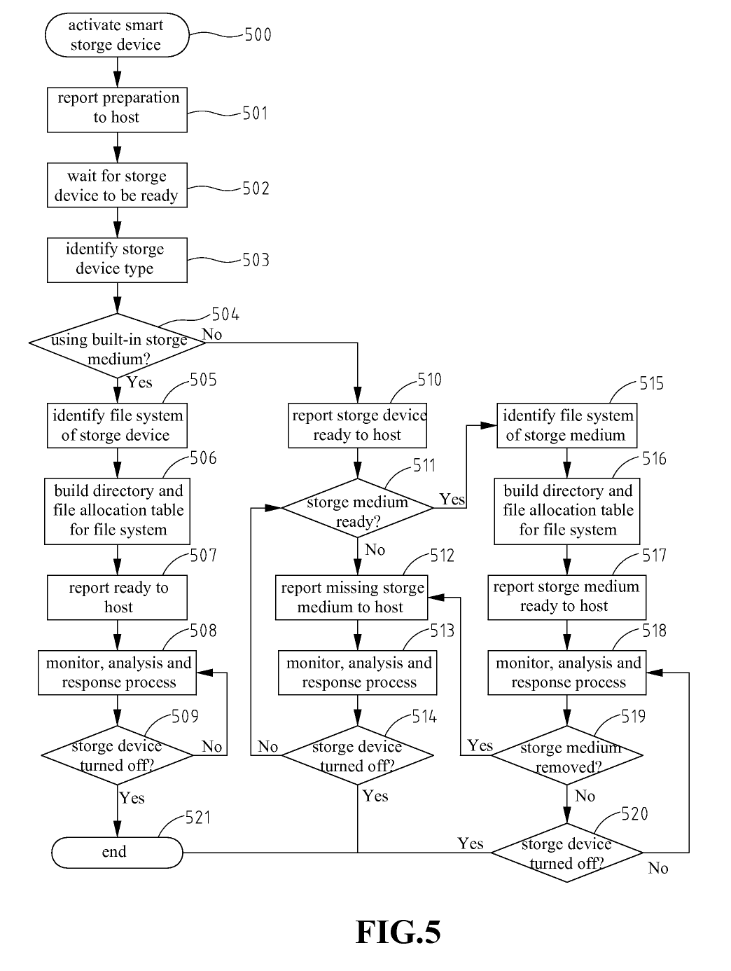

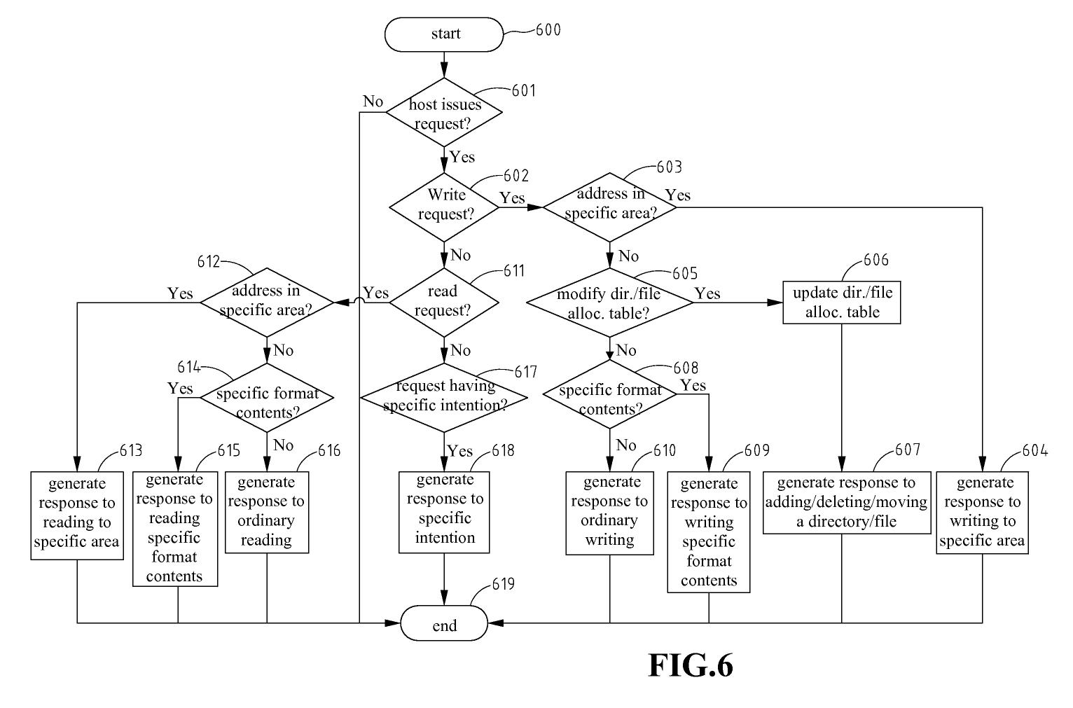

FIG. 5 shows a detailed flowchart of the operation of FIG. 4. Step 401 is expanded in more details to show the initialization taken by the present invention before the monitoring, analyzing and responding to the host request. The process starts with step 500 to activate the smart storage device. Step 501 is to report to the host with a response stating that the smart storage device is in preparation. In step 502, the smart storage device waits for the storage device to be ready. Step 503 is to identify the type of the storage medium used in the storage device. This step is necessary to determine the types of requests and commands that a host may issue to operate the storage device. Step 504 is to further determine whether the storage device uses a built-in storage medium or a removable medium. Built-in storage medium, such as hard-drive, are not removable. On the other hand, removable storage medium, such as floppy or CD, can be removed from the storage device. For the present invention, the difference is the necessity to determine the existence of the storage medium and the information reconstruction after the storage medium is connected. If the storage device uses a built-in storage medium, the process must take steps 505, 506, 507 before starting step 508, the monitoring, analysis and the response process. On the other hand, if the device uses a removable storage medium, the process must take steps 510, 511, 512 before starting step 513, the monitoring, analysis and the response process. Step 505 is to identify the file system used by the storage device. Step 506 is to build directory and file allocation table for file system. Step 506 also includes constructing a look-up table used in the request analysis. The memory in the processor can be used to store information during the look-up table construction. Additional space can be reserved in the storage medium if necessary. Step 507 is to report to the host with a response stating that the storage device is ready. Then, step 508 is to start the monitoring, analysis and response process, followed by step 509 to determine whether the storage device is turned off; if so, the process stops and exits; otherwise, return to step 508 to continue the monitoring, analysis and response process. On the other hand, when the storage device uses a removable storage medium, step 510 is taken to report to the host with a response stating that the storage device is ready. Then, step 511 is to determine whether the storage medium is ready; if so, step 515 is to is to identify the file system used by the storage device, step 516 is to build directory and file allocation table for file system, and step 517 is to report to the host with a response stating that the storage medium is ready. Then, step 513 is to start the monitoring, analysis and response process, followed by step 514 to determine whether the device is turned off; if so, the process stops and exits; otherwise, return to step 511 to check whether the storage medium is ready. Otherwise, step 512 is to report to the host with a response stating that the storage medium does not exist. Then, step 518 is to start the monitoring, analysis and response process. Step 519 is to determine whether the storage medium is removed; if so, go to step 512; otherwise, step 520 is to determine whether the device is turned off; if so, the process stops and exits; otherwise, return to step 518 to continue the monitoring, analysis and response process. It is worth noticing that steps 508, 513, 518 are the same monitoring, analysis and response process, which will be described in details later in FIG. 6. In summary, steps 504-509 are for the storage device with built-in storage medium, such as hard disk drive; steps 510-514 are for the storage with removable storage medium and the storage medium is removed from the storage device, such as a memory card reader without the memory card inserted; and steps 515-520 are for the storage device with removable storage medium ready, such as the memory card is plugged in the memory card reader.

FIG. 6 shows the detailed monitoring, analysis and response process of steps 508, 513, 518 of FIG. 5. The monitoring, analysis and response process includes three parts; that is, a monitoring part corresponding to step 402 of FIG. 4, an analysis part corresponding to step 403 of FIG. 4, and a response part corresponding to step 404 of FIG. 4, respectively. The monitoring, analysis and response process starts with step 600. Step 601 is to determine whether a request is issued by the host; if not, the process ends; otherwise, take step 602 to determine whether the request is a write request. If the request is a write request, take step 603 to determine whether the target address is in a special zone; otherwise, take step 611 to determine whether the request is a read request. The definition of the special zone can be input by the user from the input device or the host. In step 603, if the target address in the write request is in a special zone, the process takes step 604 to generate a response to indicate that a write request to a special zone has taken place; otherwise, the process takes step 605 to determine whether the write request will modify the directory or the file allocation, such as adding, deleting or moving a file or directory, and if so, take step 606 to update the directory and the file allocation table. Step 607 is to generate a response to indicate that a file or directory has been added, deleted, or moved. If the directory or the file allocation table is modified in step 605, take step 608 to determine whether the write request will write a specific format content; if so, take step 609 to generate a response to indicate that a write request will write a specific format content; otherwise, take step 610 to generated a response to indicate that the write request is an ordinary write request. There are various ways to distinguish a specific format content, for example, by placing the file into a specific directory, by using file name or extension, or by analyzing the data format, and so on. In step 611, if the request is a read request, take step 612 to determine whether the target address is in a special zone; otherwise, take step 617 to determine whether the request has other specific intention. In step 612, if the target address is in a special zone, take step 613 to generate a response to indicate that a read request to a special zone has taken place; otherwise, take step 614 to determine whether the request is to read a specific format content. In step 614, if the request is to read a specific format content, take step 615 to generate a response to indicate a read request will read a specific format content; otherwise, take step 616 to generate a response to indicate that the read request is an ordinary read request. In step 617, if the request is analyzed to have other specific intention, take step 618 to generate a corresponding response; otherwise, the process ends with step 619. There are various ways to analyze whether a request have other specific intention, including identifying the instruction code of the request, decoding the instruction parameters, tracking instruction combination, observing instruction cycles, or any of the above combinations. For example, if a host issues a start/stop request to a SCSI CD drive, the analysis of the request needs to further decode the load/eject instruction to determine whether the intention is to load or eject the CD. In addition, the host may periodically send test unit ready and request sense to the CD driver to determine whether a CD is loaded in the CD driver. All these techniques can be used in the determination of the intention of the requests from the host.

As shown in FIG. 6, it is worth noticing that step 601 makes up the monitoring part of the monitoring, analysis and response process. Steps 602, 603, 605, 606, 608, 611, 612, 614, 617 perform the analysis of the request to determine the types and the intention of the request from the host. Finally, steps 604, 607, 609, 610, 613, 615, 616, 618 are the response part of the monitoring, analysis and response process.

The monitored requests, the analysis result of the request intention and the generated response can be partially or entirely stored in the memory in the processor or in the storage medium of the storage device for later reference in the analysis. When storage space is running short, the older information can be discarded to make room for newer information.

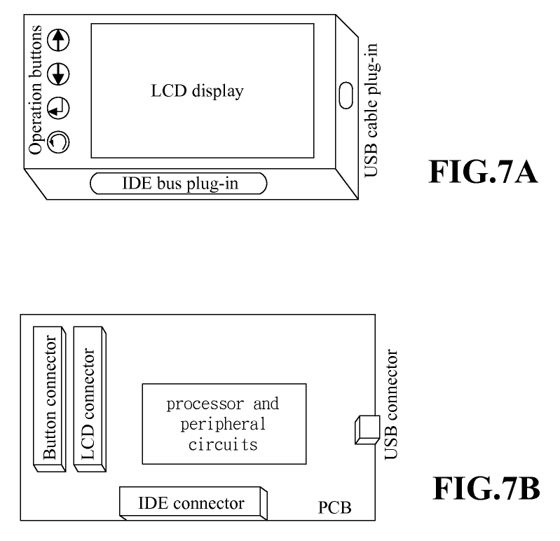

FIGS. 7A and 7B shows exterior and the interior of an embodiment of an external smart storage device shown in FIG. 3. The external smart storage of this embodiment is used to connect a PC with USB interface under the Windows XP operating system, and an MMC card reader with an IDE interface. The MMC memory card uses FAT16 file system. The exterior of the external smart storage device includes an LCD display, a plurality of operational buttons, a USB cable plug-in hole, an IDE bus plug-in hole. The interior of the external smart storage device includes a PCB, mounted with a button connector, an LCD connector, a processor and peripheral circuits, a USB connector, an IDE connector. The USB interface is for connecting the PC, and the IDE interface is for connecting the MMC card reader. The processor performs the conversion between the USB data and IDE data, as well as the monitoring, analysis and response process described in FIG. 6. The LCD is for displaying the response to the request. In this embodiment, a plurality of animation sequences can be shown in response to different requests. For example, a dog can be used as the central character in the following activities, including asleep, searching, barking, playing, rehearsing, snoozing, and so on, to response to the host requests of suspend, removal of memory card, warning of writing to booting zone, viewing audiovisual file, writing an image file, and idling. Other animation sequences or a different central character may be used in the response of the smart storage device. The buttons are input device that the user can use to operate the smart storage device.

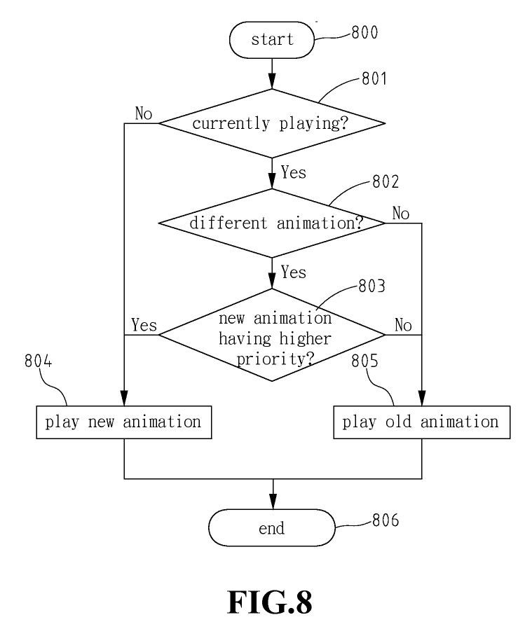

FIG. 8 shows a flowchart of the process for the LCD displaying animation sequence. The process starts with step 800. Step 801 is to determine whether an animation sequence is currently displaying on the LCD; if so, take step 802 to determine whether the second animation sequence is the same as the currently displaying animation sequence; otherwise, take step 804 to display the second animation sequence. In step 802, if the second animation sequence is the same as the currently displaying animation sequence, take step 805 to continue displaying the current animation sequence; otherwise, take step 803 to determine the priority of the current animation sequence and the second animation sequence, whichever has the higher priority will be displayed on the LCD. After the animation sequence is displayed on the LCD, the process end with step 806.

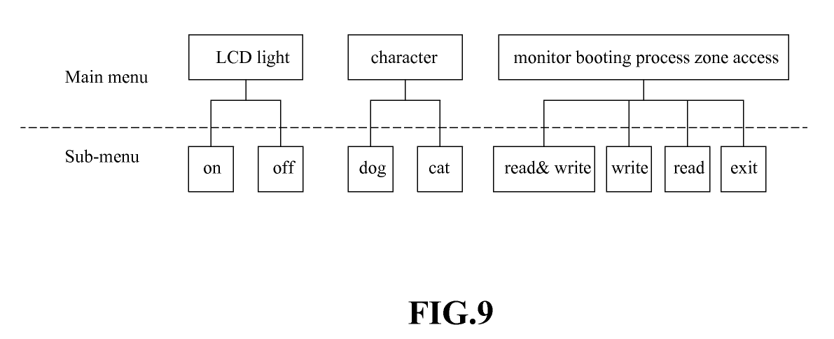

FIG. 9 shows a selection menu that the user can operate with the buttons. The main menu shows the first level of selections, including the control of the LCD light, selection of a central character, monitoring the access to the booting zone, and so on. The sub-menu shows the second level of selection in each first-level item.

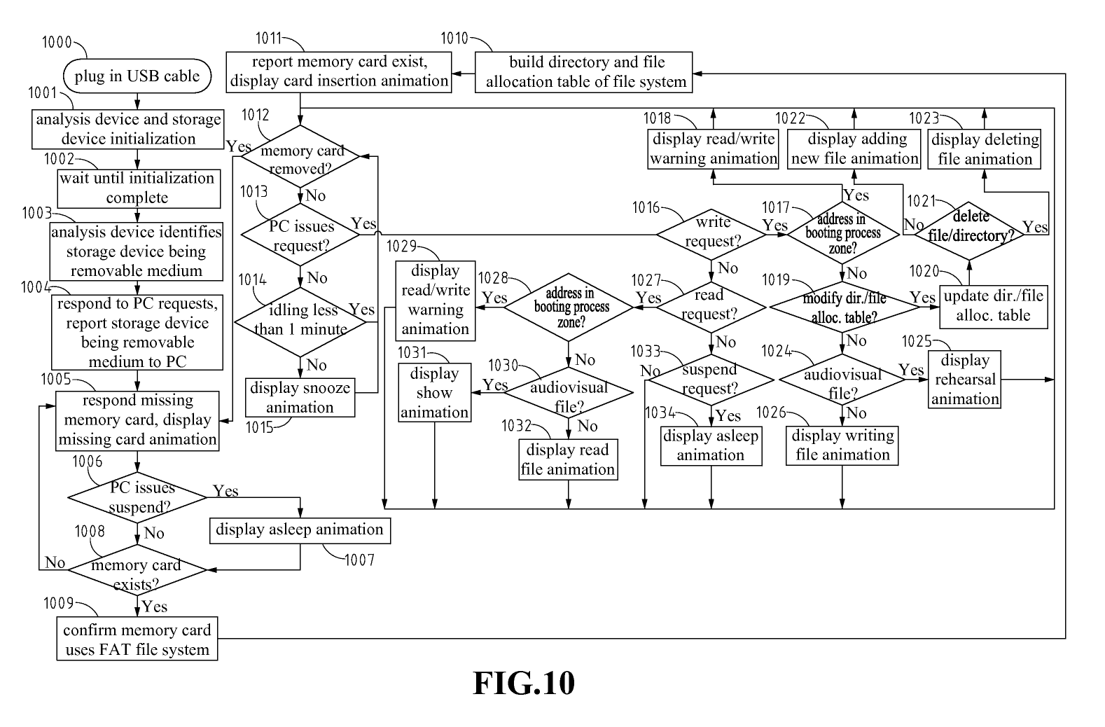

FIG. 10 shows a flowchart of the operation of the embodiment of FIGS. 7A and 7B. The process starts with step 1000 to plug in the USB cable to the smart storage device. Step 1001 is for the smart storage device of the present invention and the MMC card (storage device) reader to start initialization. Step 1002 is to suspend the response to the PC until all the initialization is complete. In step 1003, the smart storage device identifies the MMC card reader is a removable device. Step 1004 is to report to the PC and starts to respond to the PC. In step 1005, the smart storage device reports the missing memory card and displaying missing-card animation sequence. Step 1006 is to determine whether the PC issues a suspend request; if so, take step 1007 to display the asleep animation sequence; otherwise, take step 1008 to determine whether the memory card exists. Steps 1005-1008 form a loop waiting for the memory card to be inserted. In step 1008, if the memory card does not exist, return to step 1005; otherwise, the process identifies that the memory card uses FAT file system structure in step 1009, and takes step 1010 to construct file system directory and file allocation table, which is FAT in this embodiment, and step 1011 to report the existence of memory card and displaying inserting-card animation sequence. Step 1012 is to determine whether the memory card is removed; if so, return to step 1005; otherwise, take step 1013 to determine whether the PC has issued a request. If the PC issues a request, step 1016 is to determine whether the request is a write request; otherwise, step 1014 is to determine whether the card reader has been idling for more than a minute. Steps 1016-1034 are for the analysis of the issued request, and steps 1014-1015 form a loop checking the idling of the device. If idling for more than a minute, step 1015 is to display the snoozing animation sequence; otherwise, return to step 1012. Steps 1012-1015 form a loop waiting for request and checking whether the memory card is removed.

In step 1016, if the request is a write request, the process takes step 1017 to determine whether the target address is in the booting zone; otherwise, take step 1027 to determine whether the request is a read request. In step 1017, if the write request writes to a target address in the booting zone, take step 1018 to display a warning animation; otherwise, take step 1019 to determine whether the write request will modify the directory or the file allocation. In step 1019, if the write request will modify the directory or the file allocation, take step 1020 to update the directory and the file allocation table; otherwise, take step 1024 to determine whether the content is an audiovisual file, followed by steps 1025 and 1026 to display a rehearsal animation sequence or a writing-file animation sequence, respectively. The update of the directory or the file allocation table can be categorized in three different scenarios. First, the target address of the write request is in FAT; which results in the update of FAT. Second, the target address is in Root, which results in the change of the tree structure. Third, target address is in the data area, which will result in finding the cluster through translating address into a cluster and searching the reverse FAT look-up table to find the cluster of the target file. After the update in step 1020, step 1021 determines whether the write request is adding or deleting a file or directory, and followed by step 1022 or step 1023 to display an adding-file or deleting-file animation sequence, respectively. The determination of adding or deleting a file can be accomplished by comparing the file description block (FDB) to be written and the original FDB. If the request is a read request in step 1027, the process goes through steps 1028-1034, which are similar to the steps for a write request, and the description will be omitted here.

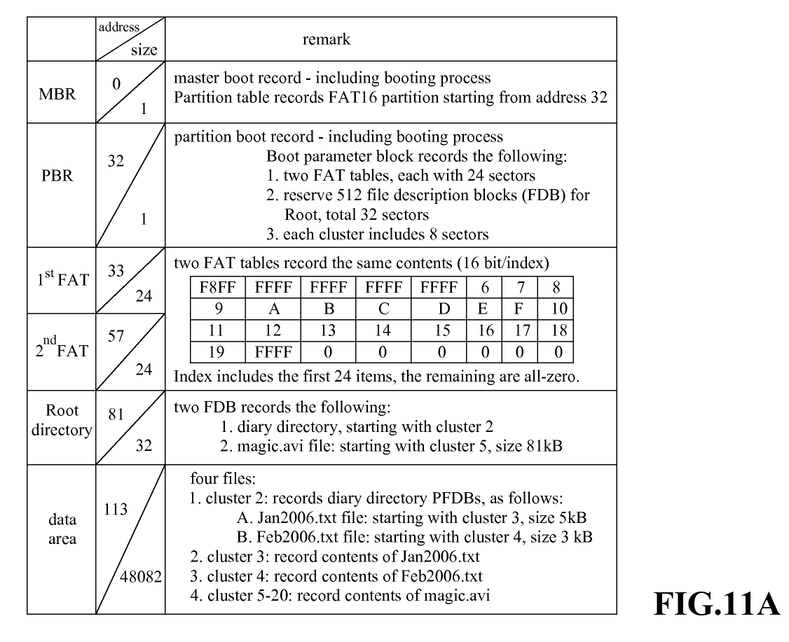

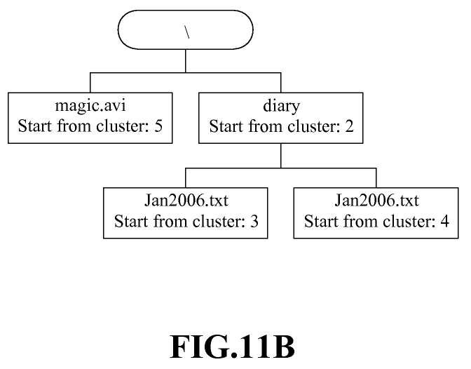

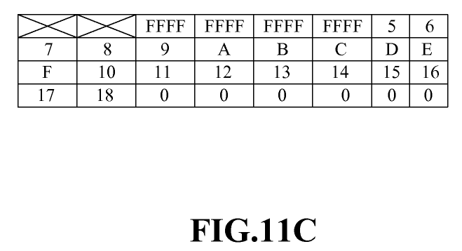

FIG. 11A shows a schematic view of the storage content of the embodiment of FIGS. 7A and 7B. FIG. 11B shows a schematic view of the tree structure generated by the smart storage device for the FAT data structure. FIG. 11C shows a schematic view of a reverse FAT look-up table generated during the construction of the tree structure of FIG. 11B.

At the end of step 1010, the smart storage device has collected and constructed the related information, including booting process, FAT, addresses of root directory and other data areas, the size of each cluster (i.e., FIG. 11A), FAT and reverse FAT look-up table (FIG. 11C), name and starting address of each directory and file (i.e., the tree structure shown in FIG. 11B), and so on. All the above information is used in the analysis of the host request, as steps 1016-1032 of FIG. 10.

This embodiment shows that the response animation sequences are only displayed on the smart storage device of the present invention. Therefore, without any installation on the host, the smart storage device can be used between the host (PC) and the conventional storage device (MMC card reader) to provide the monitoring, analysis and the response to the requests.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A smart storage device, for a host electrical device with a transmission interface, capable of monitoring requests from said host, analyzing said requests and responding accordingly with visual, audio display or control signals, said smart storage device comprising:
a transmission interface, connected to said transmission interface of said host through a transmission medium;
a processor, connected to said transmission interface, further comprising: a memory, a data transmission and medium control module for controlling data transmission, and a monitor, analysis and response (MAR) module for monitoring, analyzing and responding said requests from said host;
a control interface, connected to said processor;
a storage medium, connected to and controlled by said control interface;
an input interface, connected to said processor; and
a response interface, connected to said processor.

2. The device as claimed in claim 1, further comprising:
an input device, connected to said input interface; and
a response device, connected to said response interface.

3. The device as claimed in claim 1, wherein said host further comprises a control module for setting and controlling parameters to said smart storage device and receiving said responses from said smart storage device, and a response interface for connecting to a response device to display said responses.

4. The device as claimed in claim 1, wherein said storage medium is a flash memory.

5. The device as claimed in claim 1, wherein said storage medium is a harddisk.

6. The device as claimed in claim 1, wherein said storage medium is a floppy disk.

7. The device as claimed in claim 1, wherein said storage medium is a CD.

8. A smart storage device, for connecting between a host electrical device with a transmission interface and a storage device with a transmission interface, capable of monitoring requests from said host to said storage device, analyzing said requests and responding accordingly with visual, audio display, or control signals, said smart storage device comprising:
a host-end transmission interface, connected to said transmission interface of said host through a transmission medium;
a processor, connected to said transmission interface, further comprising: a memory, a interface data transmission module for converting data format between transmission interfaces, and a monitor, analysis and response (MAR) module for monitoring, analyzing and responding said requests from said host;
a device-end transmission interface, connected to said transmission interface of said storage device;
an input interface, connected to said processor; and
an input device, connected to said input device;
a response interface, connected to said processor.

9. The device as claimed in claim 8, further comprising:
an input device, connected to said input interface; and
a response device, connected to said response interface.

10. The device as claimed in claim 8, wherein said host further comprises a control module for setting and controlling parameters to said smart storage device and receiving said responses from said smart storage device, and a response interface for connecting to a response device to display said responses.

11. The device as claimed in claim 8, wherein said storage device is a memory card reader.

12. The device as claimed in claim 8, wherein said storage device is a harddisk drive.

13. The device as claimed in claim 8, wherein said storage device is a floppy disk drive.

14. The device as claimed in claim 8, wherein said storage device is a CD burner/player.

15. The device as claimed in claim 8, wherein said storage device is a network storage device.

16. The device as claimed in claim 8, wherein said host-end transmission interface and device-end transmission interface use different transmission protocols.

17. The device as claimed in claim 8, wherein said host-end transmission interface and device-end transmission interface use the same transmission protocols.

18. A method for a storage device to monitor, analyze and respond to request from a host electrical device, said method comprising the steps of:
initializing said storage device;
monitoring requests from said host;
analyzing the intention of said requests;
generating response to said analyzed requests; and
repeating said above monitoring, analyzing and responding steps until said storage device being turned off by said host.

19. The method as claimed in claim 18, wherein said initializing step further comprises suspending said storage device from responding to said host, determining the type and characteristics of said storage device, the existence of a storage medium in said storage device, the file system information and constructing a file allocation table.

20. The method as claimed in claim 19, wherein said type of said storage device indicates the use of a built-in storage medium.

21. The method as claimed in claim 19, wherein said type of said storage device indicates the use of a removable storage medium.

22. The method as claimed in claim 18, wherein said monitoring step comprises the recording of said requests

23. The method as claimed in claim 18, wherein said analyzing step comprises analyzing the type of said request, the target address of said request, and the data format of said request.

24. The method as claimed in claim 23, wherein said analysis is accomplished by identifying the instruction code of the request, decoding the instruction parameters, tracking instruction combination, observing instruction cycles, or any of the above combinations

25. The method as claimed in claim 18, wherein said response comprises displaying animation sequence to indicate the analysis result of said request.

26. The method as claimed in claim 18, wherein said host further comprises a control module and a response interface for setting and controlling parameters to said storage device and receiving said responses from said storage device, and a response interface for connecting to a response device to display said responses.
